(19) United States
(12) Patent Application Publication
(10) Pub. No.: US 2023/0002957 A1
(43) Pub. Date: Jan. 5, 2023

(54) IRON

(71) Applicant: Panasonic Intellectual Property Management Co., Ltd., Osaka (JP)

(72) Inventors: Wataru SANEMATSU, Kyoto (JP); Atsushi TSUJI, Osaka (JP); Yumi HANATO, Shiga (JP)

(21) Appl. No.: 17/792,555

(22) PCT Filed: Jan. 14, 2021
(86) PCT No.: PCT/JP2021/000961

§ 371 Date: Jul. 13, 2022

(30) Foreign Application Priority Data
Feb. 21, 2020 (JP) 2020-028770

(51) Int. Cl. D06F 75/24; F21V 33/00; D06F 75/26

(52) U.S. Cl. CPC D06F 75/246; F21V 33/0024; D06F 75/26

(57) ABSTRACT

An iron according to the present disclosure includes a light emitter that outputs light, and a base surface that transmits the light. A filter that suppresses transmission of visible light is provided between the light emitter and the base surface. According to the iron, the transmission of the visible light through the base surface is suppressed. Thus, the temperature on the clothes can be kept constant regardless of the color of the clothes.

### TECHNICAL FIELD

The present disclosure relates to an iron.

### BACKGROUND ART

An iron capable of ironing clothes by applying heat to the clothes by using a light emitter of a halogen lamp or the like as a heat source has been known. PTL 1 discloses a configuration of an iron that adjusts a light emission amount of a light emitter in accordance with a color tone of clothes.

### CITATION LIST

### Patent Literature

PTL 1: Unexamined Japanese Patent Publication No. H4-5998

### SUMMARY OF THE INVENTION

In the above iron, when the clothes include a plurality of color tones, the light emission amount of the light emitter cannot be appropriately controlled, and the clothes may burn or be underheated.

The present disclosure is an invention for solving the above problems, and an object thereof is to provide an iron capable of appropriately transmitting heat to clothes.

An iron according to the present disclosure includes a light emitter that outputs light, a base surface that transmits the light, and a filter that is disposed between the light emitter and the base surface and suppresses transmission of visible light.

According to the iron related to the present disclosure, heat can be appropriately transmitted to clothes.

### BRIEF DESCRIPTION OF THE DRAWINGS

FIG. 1 is a side view of an iron according to a first exemplary embodiment.

FIG. 2 is a sectional view of the iron of FIG. 1.

FIG. 3 is a block diagram illustrating an electrical connection of the iron of FIG. 1.

FIG. 4 is a sectional view of an iron according to a comparative example.

FIG. 5 is a graph representing a temporal change in a fabric temperature when ironing is performed by using the iron according to the comparative example.

FIG. 6 is a graph representing a temporal change in a fabric temperature when ironing is performed by using the iron according to the first exemplary embodiment.

FIG. 7 is a flowchart illustrating an example of first control executed by a controller of an iron according to a second exemplary embodiment.

FIG. 8 is a graph representing a temporal change in a fabric temperature when ironing is performed by using the iron according to the second exemplary embodiment.

### DESCRIPTION OF EMBODIMENT

(One Example of Practicable Mode of Iron)

an iron according to the present disclosure includes a light emitter that outputs light, a base surface that transmits the light, and a filter that is disposed between the light emitter and the base surface and suppresses transmission of visible light.

The darker the color of the clothes, the more the visible light is absorbed, and the whiter the color of the clothes, the more the visible light is reflected. Thus, heating with the visible light causes variations in a temperature on the clothes depending on the color of the clothes. According to the iron, the transmission of the visible light through the base surface is suppressed. Thus, the temperature on the clothes can be kept constant regardless of the color of the clothes.

According to an example of the iron, the filter reflects the visible light and transmits infrared rays.

According to the iron, since the visible light is reflected, the base surface is not heated. Thus, the temperature of the base surface can be kept constant.

According to an example of the iron, the filter is in contact with a surface of the base surface on the light emitter side.

According to the iron, the filter can be disposed with a simple configuration.

According to an example of the iron, the iron further includes a reflection plate that reflects the light toward the base surface.

According to the iron, the light of the light emitter can be more suitably output.

According to an example of the iron, the light emitter is a halogen lamp or a carbon heater.

According to the iron, a light emitter having a simple configuration and a suitable output can be disposed.

According to an example of the iron, the iron includes a detector that detects a temperature of the base surface.

The temperature of the base surface corresponds to the temperature of the fabric of the clothes. According to the iron, the temperature of the fabric of the clothes can be detected.

According to an example of the iron, the iron further includes a controller that controls an output of the light emitter in accordance with the temperature of the base surface detected by the detector.

According to the iron, since the output of the light emitter can be controlled in accordance with the temperature of the base surface, heat can be more suitably transmitted to the clothes.

### First Exemplary Embodiment

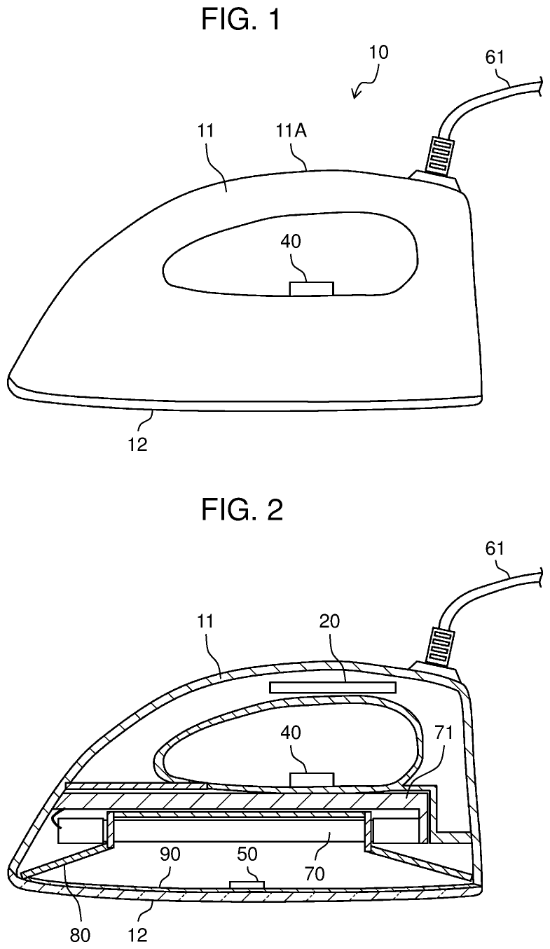

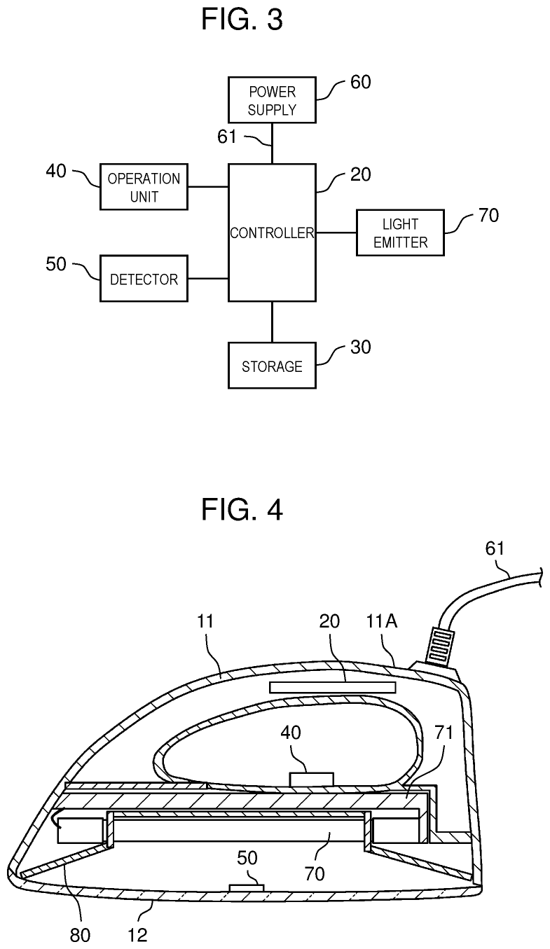

Hereinafter, iron 10 according to a first exemplary embodiment will be described with reference to FIGS. 1 to 3. Iron 10 has an iron function of smoothing wrinkles of clothes. The iron function is a function of smoothing wrinkles of clothes by applying heat and pressure of iron 10 to the wrinkles of the clothes. Main elements constituting iron 10 are housing 11 and base surface 12. Housing 11 constitutes an appearance of iron 10 and houses at least one of the other elements constituting iron 10. Although housing 11 has any shape, it is preferable that grip 11A configured to be easily held by a user is formed. Housing 11 is made of an any material having excellent heat resistance. In one example, the material of housing 11 is polycarbonate. Housing 11 includes an opening that opens an inner space. Base surface 12 is provided so as to substantially coincide with a shape of the opening of housing 11. Base surface 12 transmits heat and pressure to the clothes. Base surface 12 is made of a material having excellent heat resistance and thermal conductivity. In one example, base surface 12 is made of heat-resistant glass.

Iron 10 further includes controller 20, storage 30, operation unit 40, detector 50, power supply 60, and light emitter 70. At least one of controller 20, storage 30, operation unit 40, detector 50, power supply 60, and light emitter 70 is held inside housing 11.

Controller 20 includes an arithmetic processing unit that executes a control program. The arithmetic processing unit includes, for example, at least one or both of a central processing unit (CPU) and a micro processing unit (MPU). Controller 20 is configured to communicate with storage 30, operation unit 40, detector 50, and light emitter 70 in a wireless or wired manner Controller 20 starts control when, for example, electric power is supplied from power supply 60 and an operation signal is input from operation unit 40. Preferably, controller 20 is provided in housing 11 at a position away from light emitter 70 that is a heat generation source. In one example, controller 20 is provided at a place corresponding to grip 11A.

Storage 30 stores program information and control information for executing various controls executed by controller 20. Storage 30 includes, for example, a non-volatile memory and a volatile memory. The control information includes information in which a type of clothes is associated with an output amount of light emitter 70, and information in which a temperature of base surface 12 is associated with a temperature of the fabric of the clothes. The type of the clothes is, for example, a material of the clothes. An example of the material of the clothes is polyester, nylon, and cotton. Storage 30 is provided in the same control circuit as, for example, controller 20.

Operation unit 40 outputs an operation signal by an operation by the user to controller 20, for example. The operation signal includes, for example, a signal related to adjustment of a light emission amount of light emitter 70 and a signal related to selection of the type of the clothes. A part of operation unit 40 is configured to protrude toward an outside of housing 11 to allow the user to operate easily. Operation unit 40 is constituted by, for example, a button, a switch, and a dial. Operation unit 40 may be constituted by a touch panel.

Detector 50 detects various kinds of information about iron 10. Detector 50 detects, for example, temperature information. Detector 50 includes, for example, a thermistor. An example of the temperature information detected by detector 50 is the temperature of base surface 12. The temperature information is output, as an electric signal, to controller 20. A position where detector 50 is provided is, for example, the inside of housing 11 on base surface 12. Preferably, a center of detector 50 coincides with a center of light emitter 70 in a vertical direction of iron 10. Detector 50 may be configured to detect the number of times of use and a use time of iron 10.

Power supply 60 supplies electric power to controller 20, storage 30, operation unit 40, detector 50, and light emitter 70. In the illustrated example, power supply 60 is an external power supply such as a commercial power supply. Power supply 60 may have a configuration of a secondary battery provided inside housing 11. When power supply 60 is the external power supply, iron 10 and power supply 60 are connected by power line 61.

Light emitter 70 generates light to transmit heat to the clothes. Light emitter 70 is constituted by a halogen lamp, a ceramic heater, or a carbon heater that generates heat by electricity. A shape of light emitter 70 is any shape. In one example, the shape of the light emitter 70 is a rod shape. Controller 20 controls the light emission amount of light emitter 70 by controlling a power supply amount from power supply 60. Preferably, heat insulating member 71 is provided between light emitter 70 and controller 20. Heat insulating member 71 is made of, for example, urethane or polystyrene.

Iron 10 further includes reflection plate 80 and filter 90. Reflection plate 80 and filter 90 are provided in housing 11. Reflection plate 80 is configured to efficiently transmit light and heat of light emitter 70 to base surface 12. Reflection plate 80 is preferably configured to reflect light and heat of light emitter 70 with respect to entire base surface 12. A shape of reflection plate 80 is, for example, a bowl shape in which light emitter 70 is provided at the center. Reflection plate 80 is made of, for example, stainless steel or aluminum metal.

Filter 90 is configured to suppress transmission of light having a predetermined wavelength output from light emitter 70 through base surface 12. An example of the predetermined light is visible light. Preferably, filter 90 is configured to reflect visible light such that the visible light is not output from base surface 12 or an output amount is decreased. A shape of filter 90 is configured to substantially coincide with the shape of base surface 12. Filter 90 is configured to come into contact with light emitter 70 side of base surface 12. Filter 90 includes, for example, a dichroic mirror on which a dielectric multilayer film is deposited. Filter 90 may be configured to suppress transmission of ultraviolet rays through base surface 12.

FIG. 4 illustrates a configuration of iron 10 according to a comparative example. Iron 10 according to the comparative example has the same configuration as iron 10 according to the first exemplary embodiment except that filter 90 is not provided. In iron 10 according to the comparative example, light transmitted through base surface 12 includes visible light.

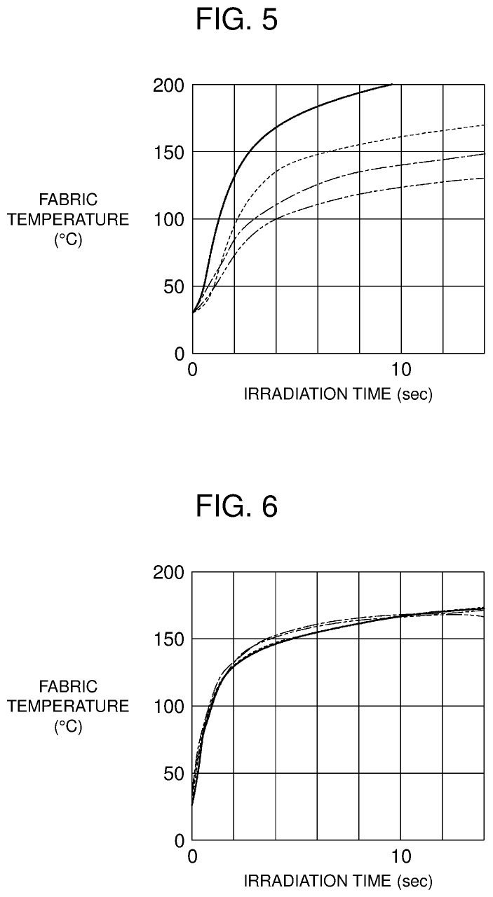

An increase in the temperature of the fabric when iron 10 according to the first exemplary embodiment or iron 10 according to the comparative example is used will be described with reference to FIGS. 5 and 6. A temporal change in the temperature of the fabric is measured by a separately prepared thermographic camera. Iron 10 includes a halogen lamp as light emitter 70. An examiner selects cotton fabric as the type of the clothes by operating operation unit 40, and controller 20 controls light emitter 70 in accordance with the cotton fabric.

Solid lines in FIGS. 5 and 6 illustrate results for black clothes made of cotton fabric. Broken lines in FIGS. 5 and 6 illustrate results for blue clothes made of cotton fabric. Dashed dotted lines in FIGS. 5 and 6 illustrate results for red clothes made of cotton fabric. Dashed double-dotted lines in FIGS. 5 and 6 illustrate results for white clothes made of cotton fabric.

As illustrated in FIG. 5, in iron 10 according to the comparative example, the variations in the temperature of the fabric increased as an irradiation time elapsed. On the other hand, as illustrated in FIG. 6, in iron 10 according to the first exemplary embodiment, the temperature of the fabric was kept constant regardless of the color of the clothes. In iron 10 according to the first exemplary embodiment, the temperature of the fabric converged within a range from 150° C. to 170° C. inclusive suitable for exhibiting the iron function.

A function of iron 10 according to the first exemplary embodiment will be described.

The user operates operation unit 40 to start supply electric power from power supply 60. The user operates operation unit 40 to select the type of the fabric of the clothes to be ironed. Controller 20 determines the output amount of light emitter 70 based on the information in which the type of the clothes stored in storage 30 is associated with the output amount of light emitter 70. Most of the light output from light emitter 70 is directed to base surface 12, and a part thereof is reflected by reflection plate 80 and directed to base surface 12. The visible light is reflected by filter 90 provided on light emitter 70 side of base surface 12. On the other hand, the infrared rays pass through filter 90 and are output from base surface 12. The clothes are heated by the infrared rays, and the user removes the wrinkles of the clothes by pressing base surface 12 of iron 10.

According to iron 10 according to the first exemplary embodiment, the following effects can be obtained.

The infrared rays output from light emitter 70 can keep the fabric temperature constant regardless of the color of the clothes. Thus, variations in heating are less likely to occur, and the clothes are hardly burned or underheated.

### Second Exemplary Embodiment

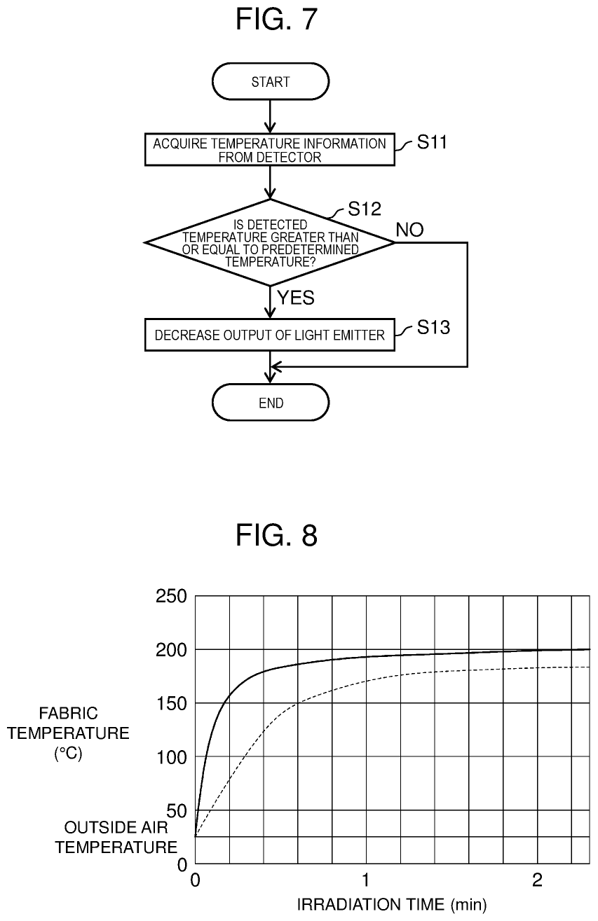

Iron 10 according to a second exemplary embodiment will be described with reference to FIGS. 7 and 8. Iron 10 according to the second exemplary embodiment is similar to iron 10 according to the first exemplary embodiment except that controller 20 executes first control for controlling the output of light emitter 70 based on the temperature detected by detector 50. Thus, the description of the same configuration will be omitted in part or whole.

Controller 20 executes the first control based on the temperature information detected from detector 50. The temperature information is, for example, the temperature of base surface 12. Controller 20 estimates the temperature of the fabric as the detected temperature from, for example, information stored in storage 30 and indicating a correspondence between the temperature of base surface 12 and the temperature of the fabric for each type of the fabric. Controller 20 decreases the output of light emitter 70 when the detected temperature is greater than or equal to a predetermined temperature. The predetermined temperature is, for example, any value of 170° C. to 200° C. inclusive. In one example, the temperature is 180° C.

An example of first control executed by controller 20 will be described with reference to FIG. 7.

In step S11, controller 20 acquires the temperature information from detector 50. Controller 20 refers to storage 30 to estimate the detected temperature that is the temperature of the fabric of the clothes. In step S12, controller 20 determines whether the detected temperature is greater than or equal to the predetermined temperature. When it is determined that the detected temperature is greater than or equal to the predetermined temperature, controller 20 executes the processing of step S13. When it is determined that the detected temperature is less than the predetermined temperature, controller 20 ends the processing. In step S13, controller 20 decreases the output of light emitter 70. After completion of processing of step S13, controller 20 ends the control. Controller 20 executes the first control at predetermined intervals while electric power is supplied from power supply 60 and light emitter 70 outputs the light.

A solid line in FIG. 8 indicates a case where the first control by controller 20 is not executed. A broken line in FIG. 8 indicates a case where the first control is executed. When the first control by controller 20 is not executed, the fabric temperature increases as the irradiation time elapsed. On the other hand, when the first control is executed, the increase in the fabric temperature is suppressed even when the irradiation time is long.

A function of iron 10 according to the second exemplary embodiment will now be described.

The user operates operation unit 40 to start supply electric power from power supply 60. The user operates operation unit 40 to select a type of fabric of target clothes. Controller 20 determines the output of light emitter 70 from the stored table of the type of the fabric of the clothes and the fabric temperature. Most of the light output from light emitter 70 is directed to base surface 12, and a part thereof is reflected by reflection plate 80 and directed to base surface 12. The visible light is reflected by filter 90 provided on light emitter 70 side of base surface 12. On the other hand, the infrared rays pass through filter 90 and are output from base surface 12. The infrared rays heat the clothes to remove the wrinkles. As the wrinkles are removed, base surface 12 is heated. Detector 50 detects the temperature information, and controller 20 decreases the output of light emitter 70 based on the temperature information.

According to iron 10 according to the second exemplary embodiment, the following effect can be obtained.

When the detected temperature is greater than or equal to the predetermined temperature, since the output of light emitter 70 is decreased, the clothes are hardly burned. Since the fabric temperature is estimated from the temperature of base surface 12, it is not necessary to newly provide a sensor for measuring the temperature of the fabric, and thus, the configuration of iron 10 can be simplified.

(Modifications)

The exemplary embodiments exemplarily describe the iron in a practicable mode of the present disclosure, and does not intend to limit the mode. The present disclosure can assume, in addition to the exemplary embodiments, following modifications of the exemplary embodiments, and any mode acquired by combining at least two modifications which do not contradict with each other, for example.

A notification unit that notifies current information detected by detector 50 may be further provided. The notification unit notifies the user of, for example, the temperature information of the fabric estimated from the current temperature of base surface 12 and the current temperature of base surface 12. When power supply 60 of iron 10 is the secondary battery, a current remaining battery level of the secondary battery may be notified.

In the first control, controller 20 may perform control of increasing the output of light emitter 70 when the detected temperature is lower than the predetermined temperature by a threshold value or more. The threshold value is, for example, 20° C.

The iron according to the present disclosure is applicable to an iron for removing wrinkles of clothes for business use and household use.

### REFERENCE MARKS IN THE DRAWINGS

10 iron

12 base surface

20 controller

70 light emitter

80 reflection plate

90 filter

1. An iron comprising:
a light emitter that outputs light;
a base surface that transmits the light; and
a filter that is disposed between the light emitter and the base surface and suppresses transmission of visible light.

2. The iron according to claim 1, wherein the filter reflects the visible light, and transmits infrared rays.

3. The iron according to claim 1, wherein the filter is in contact with a surface of the base surface, the surface facing the light emitter.

4. The iron according to claim 1, further comprising a reflection plate that reflects the light toward the base surface.

5. The iron according to claim 1, wherein the light emitter is a halogen lamp or a carbon heater.

6. The iron according to claim 1, further comprising a detector that detects a temperature of the base surface.

7. The iron according to claim 6, further comprising a controller that controls an output of the light emitter in accordance with the temperature of the base surface detected by the detector.
